(19) United States
(12) Patent Application Publication
(10) Pub. No.: US 2018/0298647 A1
(43) Pub. Date: Oct. 18, 2018

(54) SUPPLEMENTAL ACTIVE LOCK MECHANISM FOR CENTER-OPENING DOOR ASSEMBLY

(71) Applicant: FORD GLOBAL TECHNOLOGIES, LLC, Dearborn, MI (US)

(72) Inventors: Shunmugam Baskar, West Bloomfield, MI (US); Bruce Richard Ghastin, Canton, MI (US)

(21) Appl. No.: 15/487,097

(22) Filed: Apr. 13, 2017

(51) Int. Cl. E05B 77/36; E05B 83/38; B60J 5/04

(52) U.S. Cl. CPC E05B 77/36; B60J 5/0479; E05B 83/38

(57) ABSTRACT

A supplemental locking mechanism for a vehicle center-opening door assembly includes a first retaining member carried by a first door panel upper latch mechanism and a second retaining member associated with a second door panel. The second retaining member is adapted to engage the first retaining member on placing the first door panel and the second door panel in a closed and latched position.

### TECHNICAL FIELD

This disclosure relates generally to locking mechanisms for vehicle doors. In particular, the disclosure relates to a supplemental locking mechanism for a center-opening vehicle door assembly.

### BACKGROUND

When a vehicle is in motion, the vehicle door panels are subjected to significant vibration. This can be a particular problem for a vehicle equipped with a center-opening front and rear door assembly. Such vehicles typically include a front-hinge mounted front door panel and a rear-hinge mounted rear door panel, and are called center-opening because of the respective directions in which the front-hinge mounted front door panel and the rear-hinge mounted rear door panel swing while opening, i.e. they open from the center of the assembly. For such configurations, for reasons of space and rear-seat accessibility by passengers typically the vehicle is not provided with a fixed-hinge pillar by which the front door panel rear edge and the rear door front edge could be supported in a closed configuration. If the front door panel and rear door panel are not well-supported, the vibrations generated when the vehicle is in motion can create relative motion between the two panels resulting in impacts on door cutlines or primary seals, which in turn creates an undesired door to primary seal slap noise.

Existing measures to reduce door slap and attendant noise include bump stops and seal stuffers, which are costly and lack robustness. Therefore, to address this problem the present disclosure is directed to a supplemental locking mechanism, and to center-opening door assemblies incorporating same, which reduce or eliminate the tendency of the front-hinge mounted front door panel and the rear-hinge mounted rear door panel to move relative to one another when the vehicle is in motion.

### SUMMARY

In accordance with the purposes and benefits described herein, in one aspect of the present disclosure a supplemental locking mechanism for a vehicle center-opening door assembly is provided, comprising a first retaining member carried by a first door panel upper latch mechanism and a second retaining member associated with a second door panel and adapted to engage the first retaining member on placing the first door panel and the second door panel in a closed and latched position. In an embodiment, the first retaining member is a receiver and the second retaining member is a pin. In an alternative embodiment, the first retaining member is a pin and the second retaining member is a receiver.

The receiver may be operatively connected to the upper latch mechanism and the pin may be disposed on the second door panel. The receiver may travel in a vehicle-fore-aft sliding motion or a vehicle-up-down motion according to an operation of the vehicle rear door panel upper latching mechanism. In an alternative embodiment, the pin may be operatively connected to the upper latch mechanism and the receiver may be disposed on the second door panel.

In another aspect of the disclosure, a center-opening door assembly for a vehicle is provided, comprising a front-hinged door panel including a first retaining member disposed on an upper portion thereof and a rear-hinged door panel including an upper latch mechanism carrying a second retaining member adapted to engage the first retaining member on placing the front-hinged door panel and the rear-hinged door panel in a closed and latched position. In embodiments, the first retaining member is a receiver and the cooperating second retaining member is a pin. In alternative embodiments, the first retaining member is a pin and the cooperating second retaining member is a receiver.

The receiver may be operatively connected to the upper latch mechanism and the pin may be disposed on the front-hinged door panel. The receiver may travel in a vehicle-fore-aft sliding motion or a vehicle-up-down motion according to an operation of the upper latch mechanism. In alternative embodiments, the pin may be operatively connected to the upper latch mechanism and the receiver may be disposed on the front-hinged door panel.

In yet another aspect of the disclosure, methods for reducing undesired motion and noise in a vehicle center-opening door assembly are described, comprising providing a first door panel including a first retaining member disposed on an upper portion thereof and a second door panel including an upper latch mechanism carrying a second retaining member adapted to capture the first retaining member on placing the first door panel and the second door panel in a closed and latched position. In embodiments, the first retaining member may be configured as a receiver and the second retaining member may be configured as a pin. In alternative embodiments, the first retaining member may be configured as a pin and the second retaining member may be configured as a receiver.

In embodiments, the method includes operatively connecting the receiver to the upper latch mechanism and disposing the pin on the first door panel. The receiver may be adapted for a travel path defining a vehicle-fore-aft sliding motion or a vehicle-up-down motion according to an operation of the upper latch mechanism. In alternative embodiments, the method includes operatively connecting the pin to the upper latch mechanism and disposing the receiver on the first door panel.

In the following description, there are shown and described embodiments of the disclosed supplemental locking system for a center-opening door assembly. As it should be realized, the devices are capable of other, different embodiments and their several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed supplemental locking system for a center-opening door assembly, and together with the description serve to explain certain principles thereof. In the drawings:

FIG. 1 shows a side view of a vehicle including a prior art center-opening door assembly;

FIG. 2 illustrates a prior art upper latch mechanism for the center-opening door assembly of FIG. 1;

FIG. 3 shows an embodiment of a supplemental locking mechanism for the center-opening door assembly of FIG. 1;

FIG. 4 shows a pin for the supplemental locking mechanism of FIG. 2;

FIG. 5 shows a cooperating retainer capturing and releasing the pin of FIG. 3;

FIG. 6A shows a rear view of the supplemental locking mechanism of FIG. 2 operatively associated with an upper latch mechanism for a rear hinge-mounted rear door as shown in FIG. 1, with the upper latch mechanism and an associated receiver placed in a pin-releasing orientation;

FIG. 6B shows a rear view of the supplemental locking mechanism of FIG. 6A, with the upper latch mechanism and associated receiver placed in a pin-locking orientation;

FIG. 7A shows a front view of an alternative embodiment for a supplemental locking mechanism according to the present disclosure, with the upper latch mechanism and an associated receiver placed in a pin-releasing orientation;

FIG. 7B shows a rear view of the supplemental locking mechanism of FIG. 7A, with the upper latch mechanism and associated receiver placed in a pin-locking orientation; and

FIG. 8 shows a rear view of another alternative embodiment for a supplemental locking mechanism according to the present disclosure.

Reference will now be made in detail to embodiments of the disclosed supplemental locking system for a center-opening door assembly, examples of which are illustrated in the accompanying drawing figures. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

### DETAILED DESCRIPTION

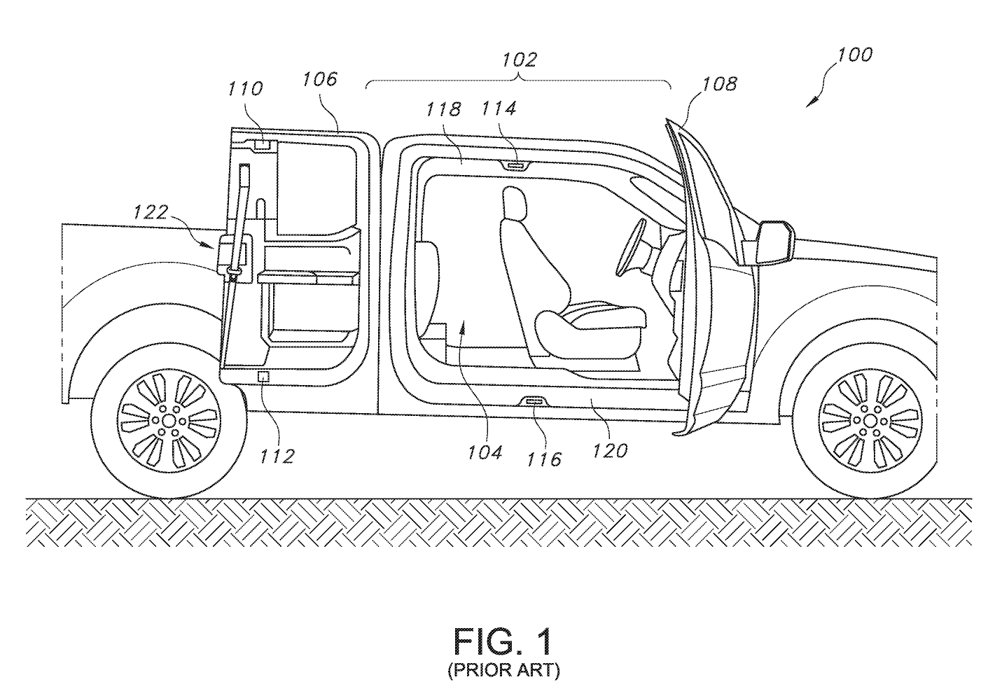

FIG. 1 illustrates a vehicle 100 including a center-opening door assembly 102 mounted to the passenger cabin 104. The center-opening door assembly 102 includes a rear hinge-mounted rear door panel 106 and a front hinge-mounted front door panel 108. As noted above, this type of center-opening door assembly 102 typically lacks a fixed-hinge pillar by which rear hinge-mounted rear door panel 106 could be supported in a closed configuration. Instead, the rear hinge-mounted rear door panel 106 is provided with upper and lower latching mechanisms 110, 112 which latch to cooperating strikers 114, 116 disposed on the vehicle roof rail 118 and rocker rail 120. The front hinge-mounted front door panel 108 latches to a mid-mounted striker 122 (not visible in this view) disposed on the rear hinge-mounted rear door panel 106.

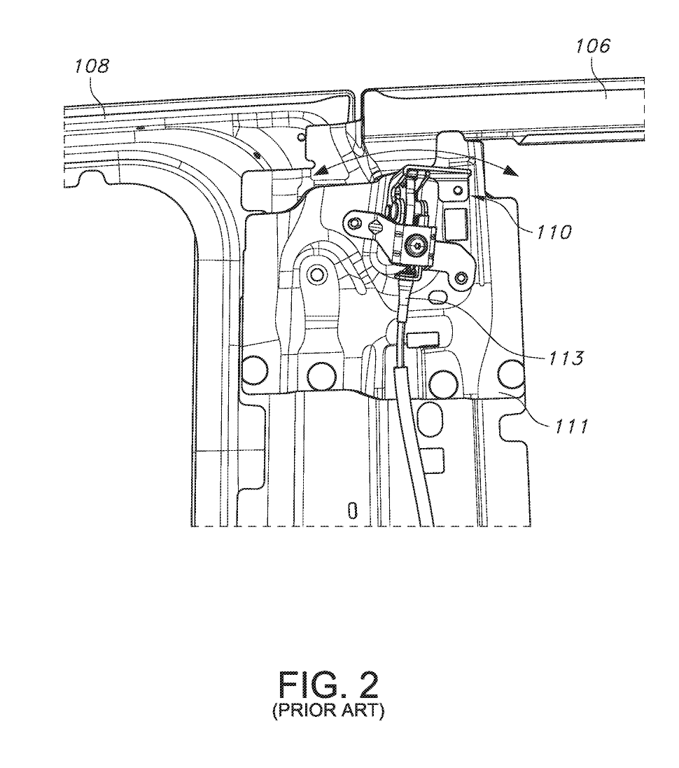

FIG. 2 illustrates in more detail a prior art upper latch mechanism 110 for a center-opening door assembly as shown in FIG. 1. The upper latch mechanism 110 is supported on a reinforcing plate 111, and articulates (see arrow) to engage a striker (not shown) under control of an actuator such as a cable 113.

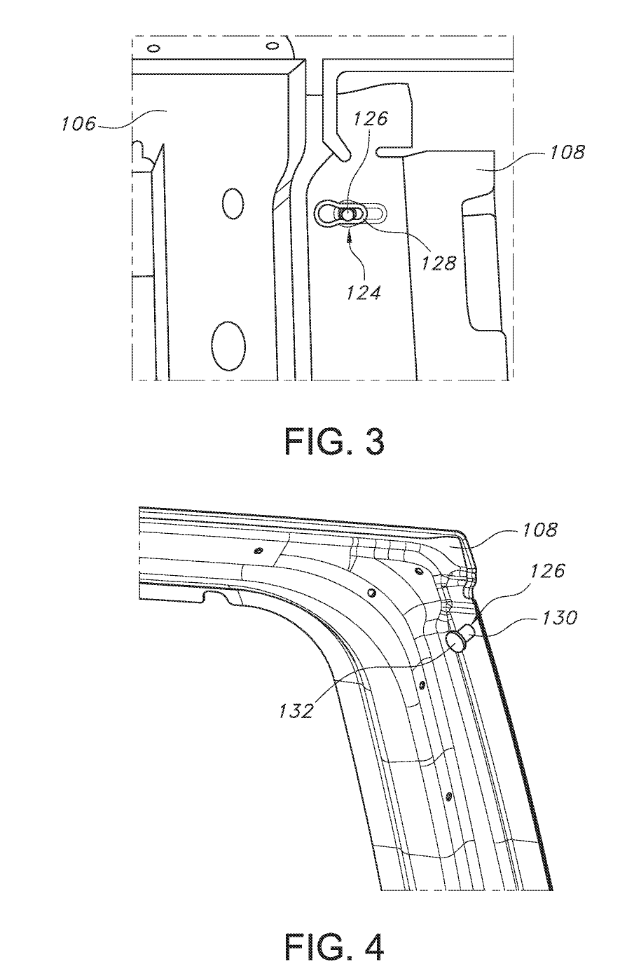

To avoid the above-identified problems of normal motion of the rear hinge-mounted rear door panel 106 relative to the front hinge-mounted front door panel 108 in a closed configuration during vehicle travel, with reference to FIG. 3 there is shown a high-level depiction of a supplemental locking mechanism 124 for a center-opening door assembly 102 as described above. The supplemental locking mechanism 124 includes a pin 126 associated with a first door panel, in the depicted embodiment being the front hinge-mounted front door panel 108. The supplemental locking mechanism 124 further includes a receiver 128 associated with a second door panel, in the depicted embodiment being the rear hinge-mounted rear door panel 106. In alternative embodiments, the pin 126 and receiver 128 may be associated with the second and first door panels, respectively. As will be described, the pin 126 and cooperating receiver 128 engage to reduce or prevent motion of the front hinge-mounted front door panel 108 normal to the rear hinge-mounted rear door panel 106.

In an embodiment (see FIG. 4), the pin 126 is defined by a stalk portion 130 and an enlarged head 132. The stalk portion 130 may be provided with a suitably dimensioned groove (not shown) to provide vehicle inboard/outboard support for the cooperating receiver 128. The pin 126 may include an elastomeric coating (not shown) such as a soft rubber or polymer to further reduce impact noise. The pin 126 may be supported on a boss (not shown) to reduce the required length of the stalk portion 130. The pin 126 may be secured to a door panel or other structure by any suitable means, such as welding, by a threaded connection, by integral forming as part of the structure, or others.

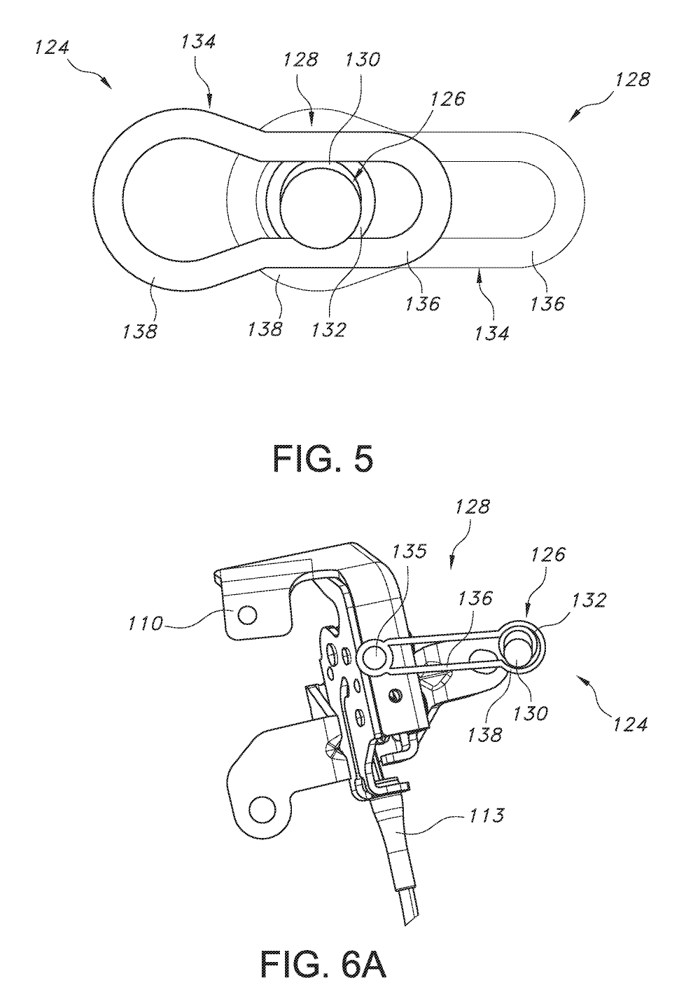

In an embodiment (see FIG. 5), the receiver 128 is defined by a closed loop body 134 including a narrower pin-engaging portion 136 and an enlarged pin-clearing portion 138. As shown in the figure, the receiver 128 may be translated (see arrow) between a pin-locking orientation and a pin-releasing orientation by simply translating the receiver whereby either the pin-engaging portion 136 captures the pin 126, or whereby the enlarged pin-clearing portion 138 is positioned to allow the pin to be withdrawn from the cooperating receiver.

In embodiments, it is contemplated to associate the described pin 126 with a door panel as shown in FIG. 4, and to associate the receiver 128 with an upper latch mechanism 110 as shown in FIG. 2. In alternative embodiments, it is contemplated to associate the pin 126 with the upper latch mechanism 110 and to associate the receiver 128 with a door panel.

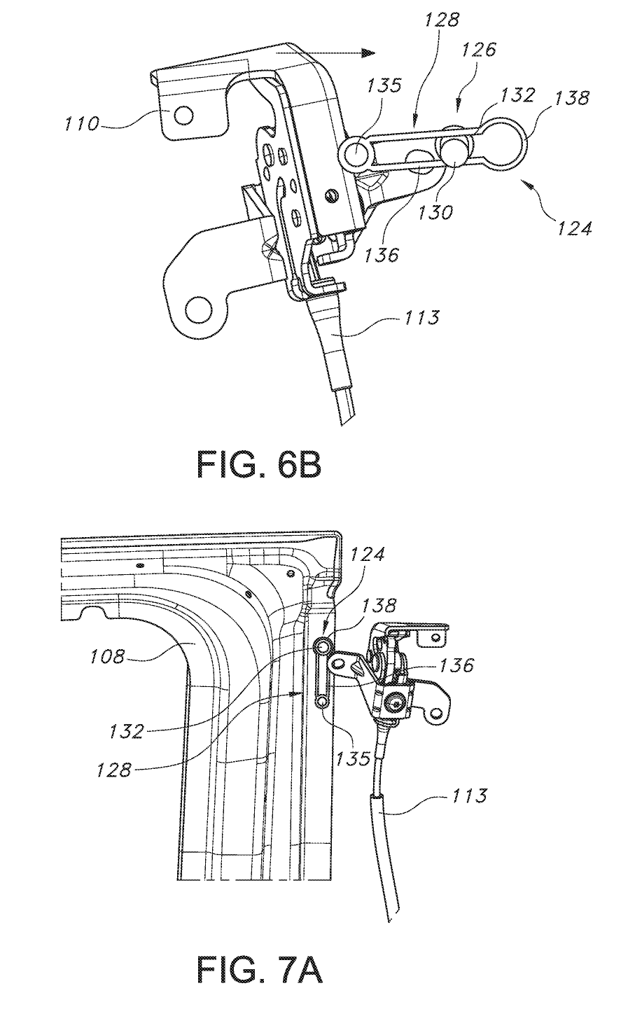

In one possible embodiment, with reference to FIGS. 6A-6B the receiver 128 may be carried by the upper latch mechanism 110, such as by way of a fastener 135 configured to articulate the receiver in a vehicle fore-aft direction. The pin 126 is disposed on the vehicle front hinge-mounted front door panel 108 (not shown in this view). As shown, the receiver 128 and pin 126 are disposed whereby when the rear hinge-mounted rear door panel 106 and front hinge-mounted front door panel 108 (not shown in this view) are in a closed but not latched position, the pin 126 is received in the receiver 128 enlarged pin-clearing portion 138.

On actuating the upper latch mechanism 110 (see arrow) to engage a striker (not shown), the receiver 128 is likewise articulated whereby the pin-engaging portion 136 engages the pin 126. The enlarged head 132 prevents inadvertent separation of the pin 126 and receiver 128. In the depicted embodiment, the receiver 128 is carried by the upper latch mechanism 110 whereby articulation of the upper latch mechanism as described causes a vehicle fore-and-aft movement of the receiver 128 to engage or release the pin 126.

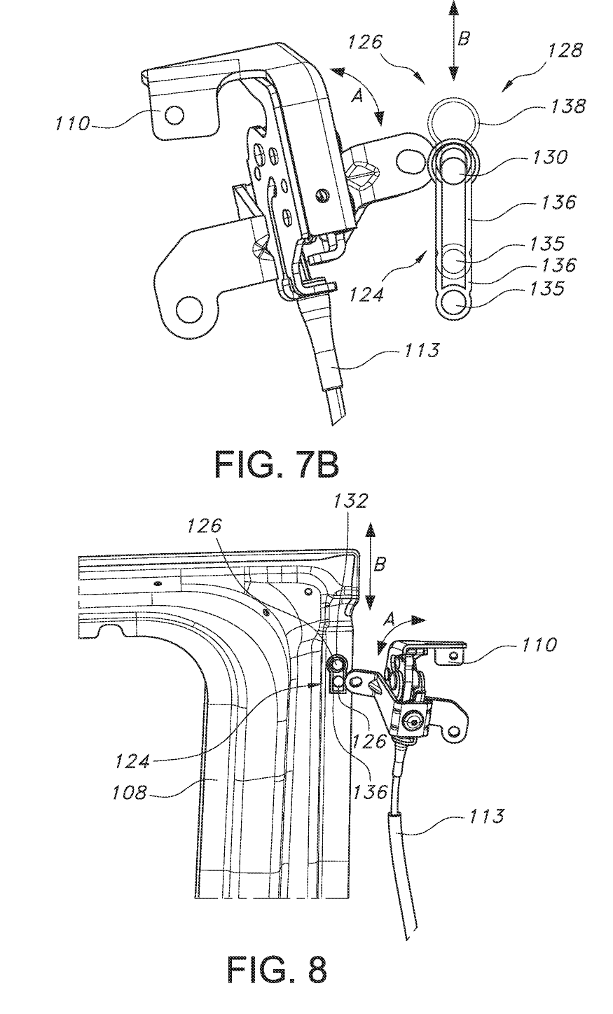

In an alternative embodiment, as shown in FIGS. 7A and 7B the receiver 128 may be carried by the upper latch mechanism 110 to cause a vehicle up-down movement of the receiver. The receiver 128 is shown separately from the upper latch mechanism 110, i.e. a partially exploded view, for clarity. However, it will be appreciated that the fastener 135 attaches the receiver 128 to the upper latch mechanism. The pin 126 is disposed on the vehicle front hinge-mounted front door panel 108 in the depicted embodiment. FIG. 7A shows the receiver 128 and pin 126 disposed whereby when the rear hinge-mounted rear door panel 106 (not shown in this view) and front hinge-mounted front door panel 108 are in a closed but not latched position, the pin 126 is received in the receiver 128 enlarged pin-clearing portion 138.

On actuating the upper latch mechanism 110 (see arrow A) to engage a striker (not shown), the receiver 128 is likewise articulated whereby the receiver translates in a vehicle-up direction and the pin-engaging portion 136 engages the pin 126. The enlarged head 132 prevents inadvertent separation of the pin 126 and receiver 128.

In yet another alternative embodiment, the receiver 128 may be associated with a door panel and the pin 126 may be adapted for movement, for example by associating the pin with the upper latch mechanism 110. With reference to FIG. 8, the receiver 128 may be disposed on the front hinge-mounted front door panel 108, and the pin 126 may be carried by the upper latch mechanism 110 (again, the drawing provides a partially exploded view of this arrangement for clarity). As shown, when the upper latch mechanism is articulated between an unlatched and a latched position (see arrow A), the pin 126 is likewise translated in a vehicle up-down motion (see arrow B) to respectively position and translate the enlarged head 132 between the narrower pin-engaging portion 136 and the enlarged pin-clearing portion 138.

So, by the described mechanisms the supplemental locking mechanism 124 secures the upper portion of the front hinge-mounted front door panel 108 to the rear hinge-mounted rear door panel 106 when the center-opening door assembly 102 is placed in a closed and latched configuration, with the attendant benefits of reducing or eliminating motion of the front hinge-mounted front door panel 108 normal to the rear hinge-mounted rear door panel 106 when the vehicle is in motion. In use, a user need only translate the center-opening door assembly 102 to a closed configuration, i.e. swinging the rear hinge-mounted rear door panel 106 and the front hinge-mounted front door panel 108 towards each other and towards a center portion of the vehicle passenger cabin 104, and latch the door panels by the upper and lower latching mechanisms 110, 112 and the mid-mounted striker 122. Concurrently, by the action of the upper latching mechanism 110, the attached cooperating receiver 128 engages the pin 126, thus providing a secure attachment for the upper portion of the front hinge-mounted front door panel 108 and reducing the tendency of the front door panel to exhibit normal motion relative to the rear panel during vehicle 100 operation and travel.

The supplemental locking mechanism 124 may be configured to secure the center-opening door assembly 102 any time the door panels are closed and latched. Alternatively, the supplemental locking mechanism 124 may be configured to secure the center-opening door assembly 102 only as the vehicle 100 reaches a predetermined speed. This can be implemented by one or more vehicle controllers (not shown) configured to apply a door locking algorithm as is known in the art. The specific details of such controller-implemented door locking algorithms and mechanisms exceed the scope of the present disclosure, and do not require extensive discussion herein. However, at a high level, in an embodiment the mechanism is activated only when the vehicle 100 reaches the predetermined speed set by the door locking algorithm, to prevent issues with vehicle entry/exit when parked.

As will readily be appreciated, the supplemental locking mechanism 124 as described herein provides a simple, effective device and method for reducing or preventing motion of an upper portion of a front hinge-mounted front door 108, without otherwise hindering normal operations of a center-opening door assembly 102 such as opening/closing. By the location of the supplemental locking mechanism 124, front hinge-mounted front door panel 108 impact velocity on seals associated with the rear hinge-mounted rear door panel 106 is reduced, reducing door slap noise. As a further advantage, minimal packaging space is required to incorporate the supplemental locking mechanism 124.

Obvious modifications and variations are possible in light of the above teachings. All such modifications and variations are within the scope of the appended claims when interpreted in accordance with the breadth to which they are fairly, legally and equitably entitled.

What is claimed:

1. A supplemental locking mechanism for a vehicle center-opening door assembly, comprising:
a first retaining member carried by a first door panel upper latch mechanism; and
a second retaining member associated with a second door panel and adapted to engage the first retaining member on placing the first door panel and the second door panel in a closed and latched position.

2. The supplemental locking mechanism of claim 1, wherein the first retaining member is a receiver and the second retaining member is a pin.

3. The supplemental locking mechanism of claim 1, wherein the first retaining member is a pin and the second retaining member is a receiver.

4. The supplemental locking mechanism of claim 2, wherein the receiver is operatively connected to the upper latch mechanism and the pin is disposed on the second door panel.

5. The supplemental locking mechanism of claim 4, wherein the receiver travels in a vehicle-fore-aft sliding motion or a vehicle-up-down motion according to an operation of the upper latch mechanism.

6. The supplemental locking mechanism of claim 3, wherein the pin is operatively connected to the upper latch mechanism and the receiver is disposed on the second door panel.

7. A vehicle including the supplemental locking mechanism of claim 1.

8. A center-opening door assembly for a vehicle, comprising:
a front-hinged door panel including a first retaining member disposed on an upper portion thereof; and
a rear-hinged door panel including an upper latch mechanism carrying a second retaining member adapted to engage the first retaining member on placing the front-hinged door panel and the rear-hinged door panel in a closed and latched position.

9. The center-opening door assembly of claim 8, wherein the first retaining member is a receiver and the second retaining member is a pin.

10. The center-opening door assembly of claim 8, wherein the first retaining member is a pin and the cooperating second retaining member is a receiver.

11. The center-opening door assembly of claim 9, wherein the receiver is operatively connected to the upper latch mechanism and the pin is disposed on the front-hinged door panel.

12. The center-opening door assembly of claim 11, wherein the receiver travels in a vehicle-fore-aft sliding motion or a vehicle-up-down motion according to an operation of the upper latch mechanism.

13. The center-opening door assembly of claim 10, wherein the pin is operatively connected to the upper latch mechanism and the receiver is disposed on the front-hinged door panel, whereby the pin travels in a vehicle-up-down motion according to an operation of the upper latch mechanism.

14. A vehicle comprising the center-opening door assembly of claim 8.

15. A method for reducing undesired motion and noise in a vehicle center-opening door assembly, comprising:
providing a first door panel including a first retaining member disposed on an upper portion thereof; and
providing a second door panel including an upper latch mechanism carrying a second retaining member adapted to capture the first retaining member on placing the first door panel and the second door panel in a closed and latched position.

16. The method of claim 15, including providing the first retaining member configured as a receiver and the second retaining member configured as a pin.

17. The method of claim 15, including providing the first retaining member configured as a pin and the second retaining member configured as a receiver.

18. The method of claim 16, including operatively connecting the receiver to the upper latch mechanism and disposing the pin on the first door panel.

19. The method of claim 18, including adapting the receiver for a travel path defining a vehicle-fore-aft sliding motion or a vehicle-up-down motion according to an operation of the upper latch mechanism.

20. The method of claim 17, including operatively connecting the pin to the upper latch mechanism and disposing the receiver on the first door panel whereby the pin travels in a vehicle-up-down motion according to an operation of the upper latch mechanism.
